(19) United States
(12) Patent Application Publication
(10) Pub. No.: US 2018/0003355 A1
(43) Pub. Date: Jan. 4, 2018

(54) ILLUMINATION DEVICE

(71) Applicant: OSRAM GmbH, Munich (DE)

(72) Inventor: Peter Hoehmann, Berlin (DE)

(21) Appl. No.: 15/632,433

(22) Filed: Jun. 26, 2017

(30) Foreign Application Priority Data
Jul. 4, 2016 (DE) 102016212078.6

(51) Int. Cl. F21S 8/10; F21K 9/64; F21V 9/16; F21Y 2115/30

(52) U.S. Cl. CPC F21S 48/1225; F21V 9/16; F21S 48/1145; F21K 9/64; F21Y 2115/30

(57) ABSTRACT

In various embodiments, an illumination device is provided. The illumination device includes at least one semiconductor light source, and a phosphor-containing light-wavelength conversion element for the wavelength conversion of light emitted by the at least one semiconductor light source. Additional phosphor is arranged on a surface of the light-wavelength conversion element.

### CROSS-REFERENCE TO RELATED APPLICATION

This application claims priority to German Patent Application Serial No. 10 2016 212 078.6, which was filed Jul. 4, 2016, and is incorporated herein by reference in its entirety.

### TECHNICAL FIELD

Various embodiments relate generally to an illumination device having at least one semiconductor light source and a phosphor-containing light-wavelength conversion element for the partial or complete wavelength conversion of the light emitted by the at least one semiconductor light source (excitation light). Such illumination devices generally emit light (used light) which is inhomogeneous in terms of color, because the wavelength conversion of the light in the light-wavelength conversion element is locally inhomogeneous, and thus the components of non-wavelength-converted light (excitation light) and wavelength-converted light (conversion light) in the light emitted by the light-wavelength conversion element also locally vary over the light emitting surface of the light-wavelength conversion element.

### SUMMARY

In various embodiments, an illumination device is provided. The illumination device includes at least one semiconductor light source, and a phosphor-containing light-wavelength conversion element for the wavelength conversion of light emitted by the at least one semiconductor light source. Additional phosphor is arranged on a surface of the light-wavelength conversion element.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic, partially sectioned illustration of an illumination device according to various embodiments;

FIG. 2 shows a schematic illustration of a cross section of the light-wavelength conversion element of the illumination device shown in FIG. 1;

FIG. 3 shows a plan view of the light-wavelength conversion element shown in FIG. 2; and

FIG. 4 shows a side view of the light-wavelength conversion element, shown in FIG. 2 and FIG. 3, without the substrate.

### DESCRIPTION

The following detailed description refers to the accompanying drawings that show, by way of illustration, specific details and embodiments in which the invention may be practiced.

Various embodiments provide a generic illumination device which emits light at least over a specific solid angle, which light is a mixture, which is as homogeneous as possible in terms of color, of non-wavelength-converted light from the at least one semiconductor light source and wavelength-converted light.

The illumination device according to various embodiments has at least one semiconductor light source and one phosphor-containing light-wavelength conversion element for the wavelength conversion of light from the at least one semiconductor light source, wherein additional phosphor is arranged on a surface of the light-wavelength conversion element.

The additional phosphor that is arranged on a surface of the light-wavelength conversion element of the illumination device according to various embodiments serves to increase the component of the wavelength-converted light in the light emitted by the light-wavelength conversion element e.g. in regions of the light-wavelength conversion element that are irradiated by the at least one semiconductor light source with a light intensity that is high compared to other regions of the light-wavelength conversion element. As a result, light that has a more homogeneous light color is emitted by the light-wavelength conversion element.

In various embodiments, the additional phosphor is limited to a section of the surface of the light-wavelength conversion element in order to locally obtain, by way of the additional phosphor, an increase of the component of the wavelength-converted light in the light emitted by the light-wavelength conversion element. The additional phosphor may therefore be arranged only on those surface sections of the light-wavelength conversion element that emit a comparatively high component of non-wavelength-converted semiconductor light source light. In various embodiments, the additional phosphor is therefore arranged with e.g. on a surface section of the light-wavelength conversion element on which the light from the at least one semiconductor light source is incident with a small angle of incidence, i.e. perpendicular or nearly perpendicular.

The phosphor-containing light-wavelength conversion element of the illumination device according to various embodiments may include a phosphor ceramic or is configured in the form of a phosphor ceramic in order to ensure good cooling of the conversion element on account of the energy introduction that is caused by a wavelength conversion of the semiconductor light source light into light having a greater wavelength.

The light-wavelength conversion element of the illumination device according to various embodiments may include a carrier for the phosphor ceramic in order to increase the mechanical stability of the phosphor ceramic and to enable good heat dissipation from the phosphor ceramic. The carrier preferably consists of sapphire, since sapphire is transparent and has a high thermal conductivity.

The additional phosphor may be arranged, by way of binders, on the surface of the light-wavelength conversion element and e.g. on a surface of the phosphor ceramic. The binder may be configured to be glass-like. As a result, the additional phosphor is reliably bonded to the surface of the light-wavelength conversion element.

In a configuration, the phosphor has already been mixed with the binder with the result that a phosphor/binder mixture is formed, which will also be referred to as additional phosphor element below. The phosphor concentration in the additional phosphor element may be higher than the phosphor concentration in the rest of the light-wavelength conversion element or than in the phosphor ceramic. However, the phosphor concentration in the additional phosphor element can generally also be the same as or less than in the phosphor ceramic. A suitable binder may be glass, e.g. waterglass, for example in the form of an alkali-silicate/water mixture, which is described by way of example in DE 10 2010 063 756 A1. The alkali-silicate can be, for example, mixtures of lithium silicate, sodium silicate or/and potassium silicate. Due to its transparency, waterglass does not effect light absorption and in addition allows for a high phosphor concentration and fusion bonding with the light-wavelength conversion element or the phosphor ceramic.

The additional phosphor or the additional phosphor/binder mixture may be arranged on top of or on the surface of the light-wavelength conversion element of the illumination device according to various embodiments and thus forms an additional phosphor layer or phosphor volume. Consequently, the phosphor concentration can be set to a desired value via the thickness or the form or via the thickness and the form of the layer or of the volume. The layer can have, for example, a circular, elliptical, polygonal or free-form periphery. The phosphor/binder mixture can be applied in multifarious forms, for example in hemispherical, conical, frustoconical, pyramidal or free-form form. The base area of the phosphor/binder mixture can be circular, elliptical, polygonal or free-form. In addition, the additional phosphor or the additional phosphor/binder mixture can thus be locally limited to selected sections of the surface of the light-wavelength conversion element that emit a high component of non-wavelength-converted semiconductor light source light. According to an embodiment, the additional phosphor or the additional phosphor/binder mixture is arranged on a surface of the phosphor ceramic.

The at least one semiconductor light source of the illumination device according to various embodiments may be configured in the form of a laser diode emitting blue light, and the phosphor in the phosphor-containing light-wavelength conversion element and the additional phosphor or the additional phosphor/binder mixture e.g. include cerium-doped yttrium aluminum garnet. As a result, the illumination device according to various embodiments produces white light that is a mixture of non-wavelength-converted blue light and light that has been wavelength-converted by the light-wavelength conversion element, e.g. yellow light. Such an arrangement is also referred to as laser activated remote phosphor (LARP).

The illumination device according to various embodiments may be configured to be a constituent part of a motor vehicle headlight and serves, for example, for producing a high beam. The illumination device according to various embodiments therefore meets the legal requirements of white light, which are set out, for example, in the ECE standard ECE/324/Rev.1/Adb.47/Reg.No.48/Rev.12 with respect to motor vehicle headlights.

In addition, the illumination device according to various embodiments can also be used for the fields of projection, effect lighting and entertainment applications, medical applications and optical applications, such as microscopy and spectroscopy.

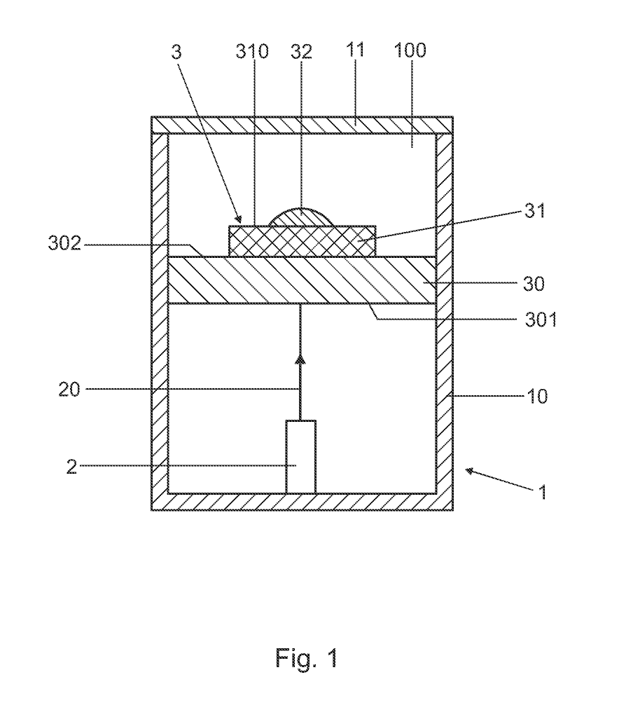

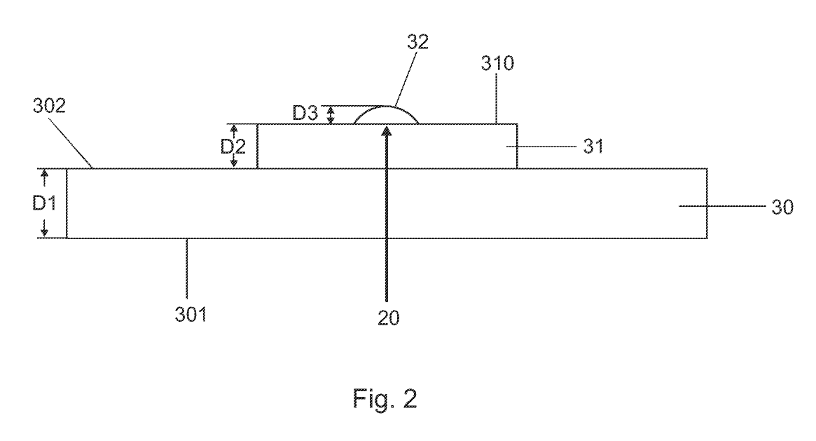

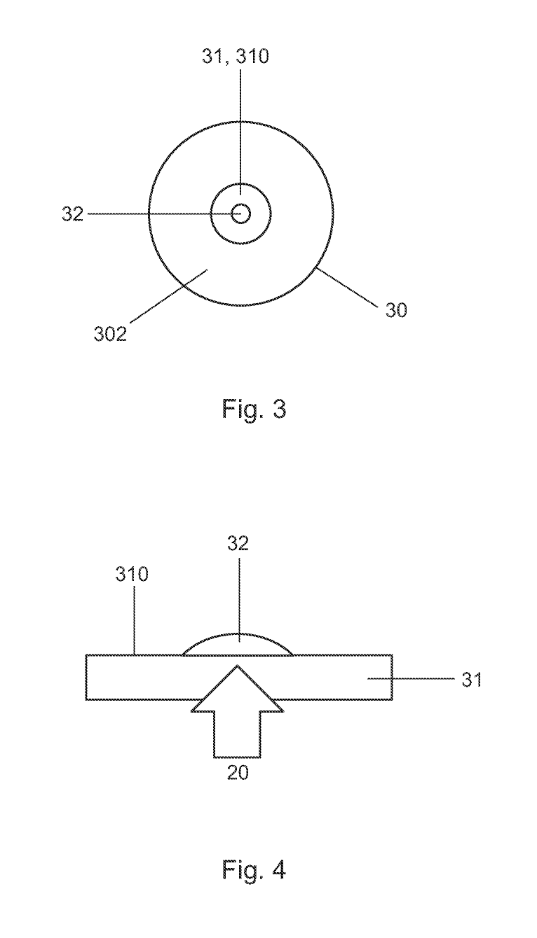

FIG. 1 schematically illustrates a partial section of an illumination device according to various embodiments, which is configured in the form of a constituent part of a motor vehicle headlight.

The illumination device 1 according to various embodiments has a cylindrical housing 10 having a light-exit opening 100, which is formed for example by a transparent housing wall or a transparent cover 11 at a front face of the housing 10, a laser diode 2 arranged within the housing 10, and a light-wavelength conversion element 3. The proportions of the individual components of this illumination device 1 are not shown to scale in FIG. 1.

The laser diode 2 produces blue light having a wavelength of 450 nanometers and an output in the range of 2 to 4 Watt during its operation.

The light-wavelength conversion element 3 consists of cerium-doped yttrium aluminum garnet (YAG:Ce), which is arranged on a transparent substrate 30 made of sapphire and is configured in the form of a ceramic phosphor 31. The substrate 30 is configured as a circular disk having a diameter of 2 mm and a thickness D1 of 0.5 mm. The phosphor ceramic 31, which may include or essentially consist of cerium-doped yttrium aluminum garnet (YAG:Ce), is configured as a circular disk having a diameter of 0.8 mm and a thickness D2 of 0.07 mm. The phosphor ceramic 31 is arranged coaxially with respect to the substrate 30 on a surface of the substrate 30. The light-wavelength conversion element 3 is arranged within the housing 10 between the laser diode 2 and the light-exit opening 100 of the housing, with the result that laser light 20 emitted by the laser diode 2 is incident centrally on a bottom side 301 of the light-wavelength conversion element 3 or substrate 30 that faces away from the light-exit opening 100. The phosphor ceramic 31 is arranged on an upper side 302 of the substrate 30 that faces the light-exit opening 100, and coaxially with respect to the substrate 30. Arranged on a surface 310 of the phosphor ceramic 31 that faces the light-exit opening 100 is additional phosphor in the form of a phosphor/binder mixture 32, which is disposed centrally on the surface 310 of the phosphor ceramic 31, wherein the waterglass also serves for bonding the phosphor/binder mixture onto the phosphor ceramic 31. The thickness D3 or height of the additional phosphor above the surface 310 is, for example, 0.03 mm. Cerium-doped yttrium aluminum garnet (YAG:Ce) serves as the additional phosphor. The additional phosphor is admixed, for example in the form of a powder, to liquid waterglass, for example liquid potassium silicate or sodium silicate, and subsequently the mixture is applied centrally onto the surface 310 of the phosphor ceramic 31 and cured at a temperature of 150-200° C. As a result, a drop-shaped phosphor/binder mixture 32 containing cerium-doped yttrium aluminum garnet (YAG:Ce) is formed on the surface 310 in the center.

The laser light 20 emitted by the laser diode 2 is incident approximately centrally on the bottom side 301 of the substrate 30 and of the light-wavelength conversion element 3 and passes through the substrate 30 made of sapphire, the phosphor ceramic 31 and the waterglass containing the additional phosphor. Here, the laser light 20 is scattered by the phosphor ceramic 31 and by the additional phosphor, and a component thereof is converted into light of a different wavelength, with the result that white light is emitted by the surface 310 of the phosphor ceramic 31 and by the surface of the waterglass containing the additional phosphor, which white light is a mixture of non-wavelength-converted blue laser light 20 and substantially yellow light that has been wavelength-converted by the phosphor ceramic 31 or by the additional phosphor.

Since the bottom side 301 of the light-wavelength conversion element 3 is illuminated only in its center with laser light 20 rather than the entire bottom side 301, the non-wavelength-converted blue component in the white mixed light emitted by the center of the surface 310 of the phosphor ceramic 31 is greater than the non-wavelength-converted blue component in the white mixed light which is emitted by the peripheral region of the surface 310 of the phosphor ceramic 31. In addition, the wavelength-converted, substantially yellow component in the white mixed light that is emitted by the center of the surface 310 of the phosphor ceramic 31 is lower than the wavelength-converted yellow component in the white mixed light that is emitted by the peripheral region of the surface 310 of the phosphor ceramic 31. Another reason for the previously mentioned inhomogeneity is the fact that, owing to light scattering and owing to the longer distance it travels in the light-wavelength conversion element 3, light from the peripheral region of the light-wavelength conversion element 3 has a higher probability of wavelength conversion.

The additional phosphor embedded in the waterglass is used to increase the wavelength-converted component of the white mixed light which is emitted by the center of the surface 310 of the phosphor ceramic 31 and to correspondingly reduce the non-wavelength-converted component. As a result, balancing of the relative components of non-wavelength-converted and wavelength-converted light in the white mixed light which is emitted by the center and by the peripheral region of the surface 310 is achieved. Overall, homogenization of the light color of the white mixed light that is emitted by the upper side of the light-wavelength conversion element 3 that faces the light-exit opening 100 is achieved.

The extent and thickness D3 of the drop 32 of waterglass containing additional phosphor on the surface 310 of the phosphor ceramic 31 and also the concentration of the additional phosphor in the waterglass can be changed in dependence on the size of the light spot of the laser light 20 on the bottom side 301 of the light-wavelength conversion element 3 and the intensity of the laser light 20 and also the properties of the phosphor ceramic 31.

### LIST OF REFERENCE SIGNS

1 illumination device
10 housing
100 light-exit opening
11 transparent cover
2 laser diode
20 laser light
3 light-wavelength conversion element
30 substrate
31 phosphor ceramic
32 additional phosphor or additional phosphor/binder mixture
301 bottom side of the substrate
302 upper side of the substrate
310 surface of the phosphor ceramic

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An illumination device, comprising:
at least one semiconductor light source; and
a phosphor-containing light-wavelength conversion element for wavelength conversion of light emitted by the at least one semiconductor light source;
wherein additional phosphor is arranged on a surface of the light-wavelength conversion element.

2. The illumination device of claim 1,
wherein the additional phosphor is limited to a section of the surface of the light-wavelength conversion element.

3. The illumination device of claim 1,
wherein the phosphor-containing light-wavelength conversion element comprises a phosphor ceramic.

4. The illumination device of claim 3,
wherein the phosphor-containing light-wavelength conversion element comprises a carrier for the phosphor ceramic.

5. The illumination device of claim 1,
wherein the additional phosphor is arranged by way of binders on the surface of the light-wavelength conversion element.

6. The illumination device of claim 5,
wherein the binder comprises glass.

7. The illumination device of claim 6,
wherein the binder comprises waterglass.

8. The illumination device of claim 1,
wherein the additional phosphor is arranged in a layer on the surface of the light-wavelength conversion element.

9. The illumination device of claim 3,
wherein the surface of the light-wavelength conversion element on which the additional phosphor is arranged is a surface of the phosphor ceramic.

10. The illumination device of claim 1,
wherein the phosphor in the phosphor-containing light-wavelength conversion element and the additional phosphor comprise cerium-doped yttrium aluminum garnet (YAG:Ce), and the at least one semiconductor light source is a laser diode producing blue light.

11. The illumination device of claim 1,
wherein the illumination device is configured as a constituent part of a motor vehicle headlight.
